(19) United States
(12) Patent Application Publication
(10) Pub. No.: US 2026/0273624 A1
(43) Pub. Date: Sep. 17, 2026

(54) METHODS AND SYSTEMS FOR ADDITIVE MANUFACTURING

(71) Applicant: Ohio State Innovation Foundation, Columbus, OH (US)

(72) Inventor: Sarah WOLFF, Columbus, OH (US)

(21) Appl. No.: 19/473,434

(22) PCT Filed: Apr. 8, 2024
(86) PCT No.: PCT/US2024/023630

§ 371 Date: Oct. 7, 2025

Related U.S. Application Data
(60) Provisional application No. 63/494,892, filed on Apr. 7, 2023.

(51) Int. Cl. B22F 10/25; B22F 10/30; B22F 10/85; B22F 12/30; B22F 12/53; B22F 12/55; B33Y 10/00; B33Y 30/00; B33Y 40/00; B33Y 50/02; C22C 29/00; C22C 29/06

(52) U.S. Cl. CPC B22F 10/25; B22F 10/30; B22F 10/85; B22F 12/30; B22F 12/53; B22F 12/55; B33Y 10/00; B33Y 30/00; B33Y 40/00; B33Y 50/02; B22F 2202/05; B22F 2302/105; B22F 2998/10; C22C 29/005; C22C 29/065

(57) ABSTRACT

Provided herein are methods, systems, and devices for additive manufacturing. Also provided herein are builds produced by the methods, systems, and devices described herein, including builds that are suitable for use in high-temperature, hydrogen environments. An additive manufacturing system for layer-by-layer manufacturing of a three-dimensional build comprises: a build platform holding a build under construction: a deposition head comprising a primary nozzle for directing a particle stream at the build under construction; a directed energy source for melting the particle stream, thereby forming a melt pool; an auxiliary powder nozzle arranged to direct an additive powder stream at the melt pool; and one or more magnets arranged to apply a magnetic field within the melt pool.

### CROSS-REFERENCE TO RELATED APPLICATIONS

This application claims benefit of priority of U.S. Provisional Application No. 63/494,892, filed Apr. 7, 2023, which is incorporated herein by reference.

### FIELD

The present disclosure is generally related to methods, systems, and devices for additive manufacturing. The disclosure also relates to builds produced by the methods, systems, and devices described herein, including builds that are suitable for use in high-temperature, hydrogen environments.

### BACKGROUND

Additive manufacturing, or the sequential assembly or construction of a part through the combination of material addition and applied energy, takes on many forms and currently exists in many specific implementations and embodiments. Additive manufacturing can be carried out by using any of a number of various processes that involve the formation of a three-dimensional part (referred to as a build) of virtually any shape. The various processes have in common the sintering, curing, or melting of liquid, powdered, or granular raw material in a layer-by-layer fashion using applied energy, such as ultraviolet light, high powered laser, or electron beam, respectively. While existing additive manufacturing methods are suitable for many applications, improved methods and systems for additive manufacturing are needed, particularly to construct builds which possess tuned properties for particular applications or environments.

### SUMMARY

Provided herein are additive manufacturing systems for the layer-by-layer manufacturing of a three-dimensional build. The additive manufacturing system can comprise a build platform holding a build under construction; a deposition head comprising a primary nozzle for directing a particle stream at the build under construction; a directed energy source for melting the particle stream, thereby forming a melt pool; and an auxiliary powder nozzle arranged to direct an additive powder stream at the melt pool, one or more magnets arranged to apply a magnetic field within the melt pool, or a combination thereof.

Also provided herein are methods of using the systems described herein to form builds, as well as builds prepared by these methods. In some embodiments, the builds can exhibit improved properties rendering them suitable for use in high-temperature, hydrogen environments.

### BRIEF DESCRIPTION OF THE FIGURES

FIG. 1 illustrates an example heat exchanger design for hydrogen storage.

FIG. 2 shows an overview, task breakdown, and relationship among the experimental efforts outlined in Example 1, including hybrid AM manufacturing at the lab-scale, material characterization, mechanical testing (where validation methods will be used with and without hydrogen testing, and a scale up of the proposed manufacturing process.

FIG. 3 schematically illustrates aspects of the proposed additive manufacturing technology described herein, as exemplified for IN718 metal matrix composites with SiC powder particles: 1) preparation of the melt pool with a magnetic field to control flow and solidification; 2) deposition of multiple materials; 3) solidification results in a final structure that can perform in harsh environments.

FIG. 4A is a schematic illustration of simultaneous laser melting and X-ray imaging where permanent magnets induce a transverse magnetic field through the melt pool.

FIG. 4B illustrate melt pool depth as a function of time during laser melting.

FIG. 5A is a schematic of flow trajectories of interest in the laser-induced melt pool.

FIG. 5B shows an example of tungsten particle tracking in an X-ray image.

FIG. 5C shows flow velocity measurements for the S1 trajectory in laser-melted 316L SS.

FIG. 6 shows high-speed synchrotron X-ray imaging of zirconium particles entering and mixing in an Al6061 melt pool. Time t₀ indicates when the laser turns on, the labeled line outlines the melt pool, and the scale bar refers to 200 microns.

FIG. 7 illustrates how a magnetic field can modify phase transformations and dendrite growth during solidification (left) and the cooling rates to modify phase transformations (right).

FIGS. 8A-8B show (FIG. 8A) an SEM-EBSD IPF and (FIG. 8B) KAM map of the same area showing distribution of misorientation across the deformed microstructure in wire arc additive manufactured nickel-aluminum-bronze alloys. Highlighted areas correspond to regions with high misorientation values. High misorientations reflect changes in crystallographic orientation because of dislocation accumulation.

FIG. 9 shows an SEM-EBSD inverse pole figure (IPF) map of DED IN625 showing grains oriented along the <001> direction.

FIG. 10 shows electron channeling contrast imaging (ECCI) of an as-deformed microstructure. Analysis revealed bands of high dislocation density within a-grains (outlined in circle).

FIGS. 11A-11C show 3D reconstructed porosity at (FIG. 11A) load step 0 (as-built condition), (FIG. 11B) load step 4, and (FIG. 11C) load step 5 (failure). Internal pores are and surface-connected pores are highlighted.

FIG. 12 is a schematic illustration of hydrogen attack of an Inconel alloy.

FIG. 13A shows stepped isostress method (SSM) testing of wrought IN718 at 750° C. subjected to different initial loads.

FIG. 13B shows predictions of stress-rupture based on SSM data.

FIG. 14A shows the results of dynamic negative stress tests (DNSTs) of electron beam melted (EBM) Ti-6Al-4V built in six orientations at 650° C.

FIG. 14B shows a creep resistance plot of electron beam melted (EBM) Ti-6Al-4V built in six orientations at 650° C.

FIG. 14C shows scanning electron microscopy (SEM) micrographs of 60 and V specimens.

FIG. 15 schematically illustrates the use of applied magnetic fields on the melt pool to influence the microstructure and mechanical properties of builds.

FIG. 16 illustrates an example additive manufacturing system described herein.

FIG. 17 illustrates an example additive manufacturing system described herein.

FIG. 18 illustrates an example additive manufacturing system described herein. This example system includes an integrated deposition head and a couple magnet.

FIG. 19 illustrates an example additive manufacturing system that includes an integrated deposition head and an auxiliary nozzle arranged to direct an additive powder stream at the melt pool.

FIGS. 20A-20C are photographs of an example additive manufacturing system that includes an auxiliary nozzle arranged to direct an additive powder stream at the melt pool.

### DETAILED DESCRIPTION

Before the present methods, compositions, systems, articles, devices, and/or methods are disclosed and described, it is to be understood that the aspects described below are not limited to specific compounds, specific devices, synthetic methods, or uses as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an” and “the” include plural referents unless the context clearly dictates otherwise. Thus, for example, reference to “a pharmaceutical carrier” includes mixtures of two or more such carriers, and the like.

“Optional” or “optionally” means that the subsequently described event or circumstance can or cannot occur, and that the description includes instances where the event or circumstance occurs and instances where it does not. For example, the phrase “optionally substituted lower alkyl” means that the lower alkyl group can or cannot be substituted and that the description includes both unsubstituted lower alkyl and lower alkyl where there is substitution.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

The disclosure is directed, at least in part, to methods and systems for directed energy deposition (DED, such as laser directed energy deposition). In one embodiment, the system can include at least one deposition head for directing material (such as in the form of a particle stream) towards a part/build and at least one energy source (e.g., a laser beam) for melting the material to form a melt pool. In one embodiment, energy source melts the particle stream as it comes into contact with the part/build. The system can further include one or more magnets positioned to generate a magnetic field within the melt pool. The magnetic field can control the melt pool fluid flow by altering the Marangoni effect with the Lorentz force. The magnetic field can also control melt pool dimensions. This is like beam shaping, but a magnetic field also influences fluid flow in the melt pool as well as the mechanisms of solidification for refined grain structure. The system can further include one or more auxiliary nozzles arranged to deliver an additive powder to the melt pool. The additive powder can be injected into the melt pool to provide for grain refinement (e.g., the additive powder can serve as areas for grain nucleation when deposited, or injected, into the melt pool). An auxiliary nozzle can be used to inject the additive powder at desired depths into the melt pool by changing the gas pressure, which also modifies the particle velocity, allowing the particles to break the surface energy of the high surface tension melt pool.

In some embodiments, the system can include both one or more magnets positioned to generate a magnetic field within the melt pool and one or more auxiliary nozzles arranged to delivery an additive powder to the melt pool. The combination of a magnetic field (which will set the correct conditions for melt pool flow) and tunable nozzle parameters can allow for controlled locations and grain nucleation of particle deposition.

In a directed energy deposition process, as material (e.g., a powder) and energy are added to the part or component, certain characteristics of the part, such as, but not limited to, the part geometry, surface roughness and material properties such as mechanical properties and microstructure, may be affected or controlled by the melt pool. The part geometry and roughness may be determined by the resolution of the directed energy deposition system, which depends on the size of the melt pool. The mechanical properties and microstructure of the part depend on the changes in cooling rates between the material being deposited and the rest of the part which is partially affected by the shape of the melt pool. As discussed above, the properties of the resulting part can thus be tuned by altering the characteristics of applied magnetic field (e.g., field strength, field shape, or a combination thereof) and/or the addition of an additive powder (e.g., composition of the additive powder, concentration of the additive powder, nozzle parameters used to in

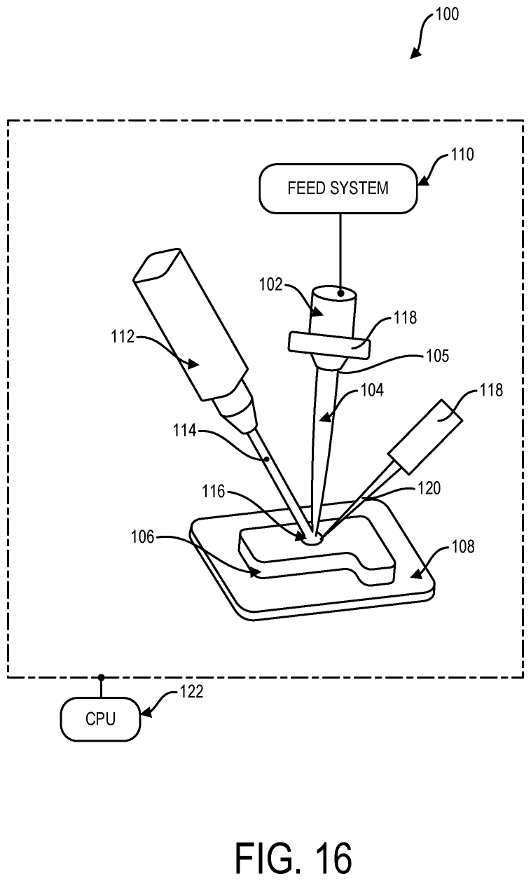

Referring now to FIG. 16, a perspective view of a system for directed energy deposition is shown. The system 100 includes at least one deposition head 102 for supplying or directing material (such as in the form of particle stream or powder 104) towards a part 106 being fabricated. Alternatively, instead of being fabricated, the part may be being repaired by the directed energy deposition. In the current embodiment, the part being fabricated rests atop a build plate 108. Depending on the design of the directed energy deposition system, the build plate 108 may be permanently fixed with respect to the nozzle or may include control elements whereby the position of the build plate 108 may be moved with respect to the nozzle (e.g., in the x, y, and/or z direction) such that the position of the part 106 can be moved during directed energy deposition. Alternatively, or in addition, the deposition head my be permanently fixed with respect to the build plate or may include control elements (e.g., such as an actuating robotic arm) which allows the deposition head to be moved with respect to the build plate.

The at least one deposition head 102 can be connected to a material feed system 110, which provides the particles or material that is directed at the part 106 by the deposition head 102. In other words, the material feed system supplies the material needed to fabricate or repair the part 106. In one embodiment, the material may be in the form of a powder or material particles.

In one embodiment, the powder or material particles are accelerated by the material feed system 110 to and through the deposition head 102 using a gas flow and/or gravitational force, although other methods of transmitting or transporting the material from the material feed system 110 to the nozzle 102 are contemplated. In certain embodiments, the powder or material particles are accelerated by the material feed system 110 to and through a primary nozzle 105 of the deposition head 102 using a gas flow.

The part resolution and surface roughness may be controlled or determined by the deposition head/primary nozzle design and dimensions. The material feed system 110 may further provide a shielding gas that surrounds the particle stream to assist in particle or particle stream focusing and to reduce the likelihood or prevent chemical reactions between the particle stream (or powder) and atmosphere. In one embodiment, this produces a particle stream with a fixed distance and direction from the nozzle to a location of low, or minimum particle stream cross-section width (particle focus point) and a fixed particle stream cross-section shape. The cross-sectional size and shape of the particle stream refer to a cross-sectional shape of the particle stream, normal to the particle stream path. In some embodiments, the cross-sectional shape may be defined with respect to the powder concentration distribution which may be described by a Gaussian function that has an infinite extent whereby the cross-section may be defined the radius of the particle stream where a threshold value is chosen to drop the edges of the powder concentration distribution function.

The system 100 can further include energy sources 112 that supply energy beams 114 to melt the material when it contacts the part 106, in the form of melt pools 116. The term ‘energy beam’ used in this disclosure is used in a general sense to describe a narrow, propagating stream of energy particles and/or packets of energy which may include a light beam, a laser beam, an electron beam, a particle beam, a charged-particle beam, a molecular beam, etc., which upon contact with a material imparts kinetic (thermal) energy to the material. These melt pools 116, at different times within the part build, or directed energy deposition process, may be stationary or moving with respect to part 106.

Referring still to FIG. 16, in some embodiments, the system 100 further includes one or more magnets 118 arranged to apply a magnetic field within the melt pool 116. In some embodiments, the one or more magnets can comprise one or more permanent magnets. In some embodiments, the one or more magnets comprise an electromagnet. The one or more magnets can induce a transverse magnetic field through the melt pool. In some embodiments, the one or more magnets 118 are positioned proximate to the deposition head 102. In certain embodiments, the one or more magnets 118 are coupled to the deposition head 102.

In some embodiments, the one or more magnets 118 are circumferentially disposed around the particle stream 104. In some embodiments, the one or more magnets 118 are circumferentially disposed around an energy beam 114 emitted from the directed energy source 112. In certain embodiments, the one or more magnets 118 are circumferentially disposed around both the particle stream 104 and the energy beam 114 emitted from the directed energy source 112. In certain embodiments, the one or more magnets 118 are arranged such that a distance between the one or more magnets and the melt pool 116 remains substantially constant throughout layer-by-layer manufacturing of the three-dimensional build. In some embodiments, the one or more magnets are configured to influence melt pool fluid flow, control the melt pool dimensions, or a combination thereof.

Referring again to FIG. 16, in some embodiments, the system 100 further includes one or more auxiliary powder nozzles 121 arranged to direct an additive powder stream 120 at the melt pool 116. In some embodiments, the one or more auxiliary powder nozzles 121 are separate and spaced apart from the deposition head 102. In some embodiments, the one or more auxiliary powder nozzles 121 are sized to deliver a stream of single additive powder particles to the melt pool.

The system may further include a central processing unit (CPU) 122 for controlling the components of the system. For instance, the CPU may control operation of the energy sources 112 and the deposition head 102 (e.g., to open and/or close the primary nozzle(s) 105), when required. The CPU 122 may also control the build plate 108 to move the plate 108 with respect to the nozzle 102. In some embodiments, the one or more magnets can comprise an electromagnet, and the CPU can be coupled to the electromagnet and configured to modulate strength of the magnetic field within the melt pool, shape of the magnetic field within the melt pool, or a combination thereof. In some embodiments, the CPU can be coupled to the auxiliary powder nozzle and configured to modulate gas pressure within the auxiliary powder nozzle, thereby altering a velocity of the additive powder stream. The CPU can also modulate operating parameters of the system in order to generate builds having desirable characteristics. For example, the CPU can tune process parameters such as laser power, scan speed, powder deposition rates, and/or magnetic field in order to achieve a build with the desired microstructure (including grain size, phases, and porosity) and/or mechanical properties.

Although only a single particle stream (and deposition head) is shown with respect to FIG. 16, the material may be provided using one or more material feed systems and nozzles (providing a corresponding number of particle streams) or any combination thereof. With multiple material feed systems and multiple deposition heads, multiple melt pools may be enabled. Alternatively, there may be a single material feed system connected to multiple deposition heads. The selection and design of the material feed system and deposition head combinations may be based on the required materials for the part manufacture or repair.

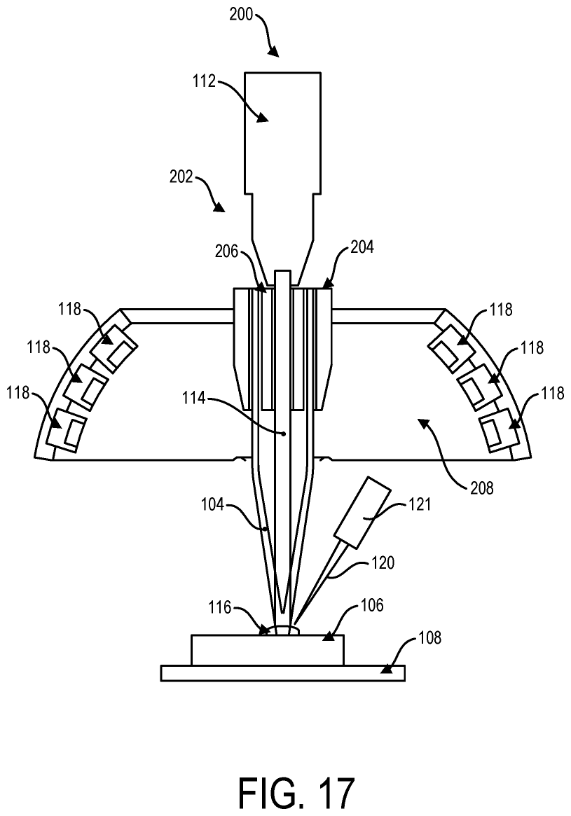

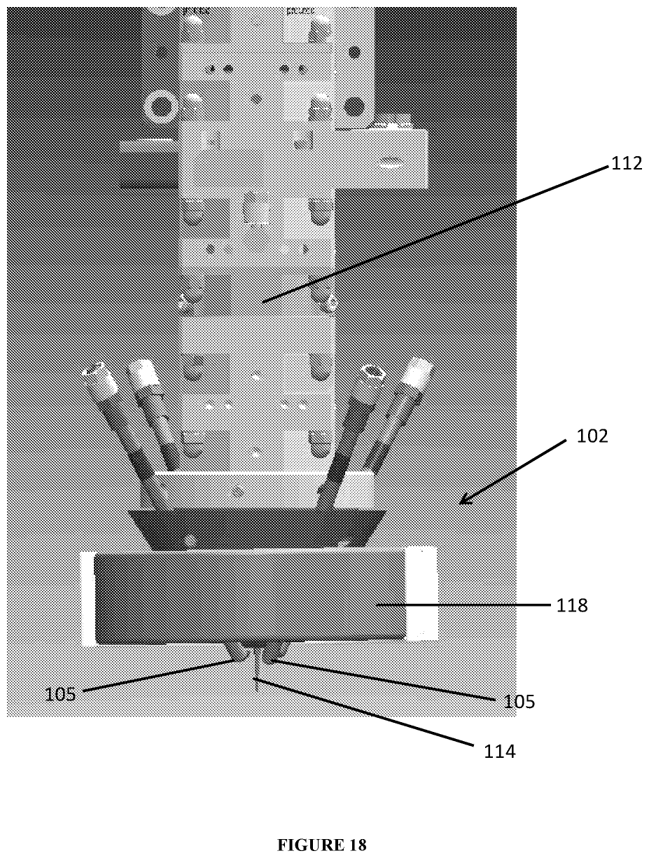

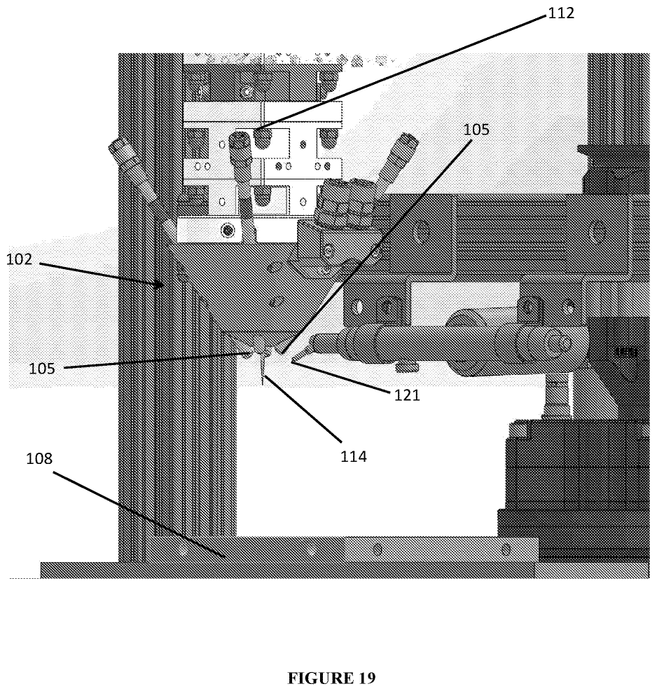

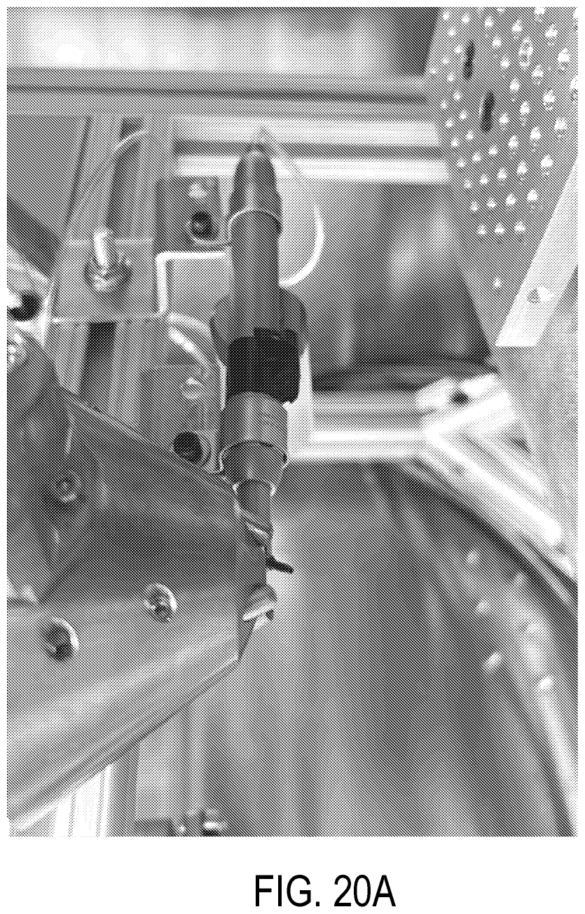

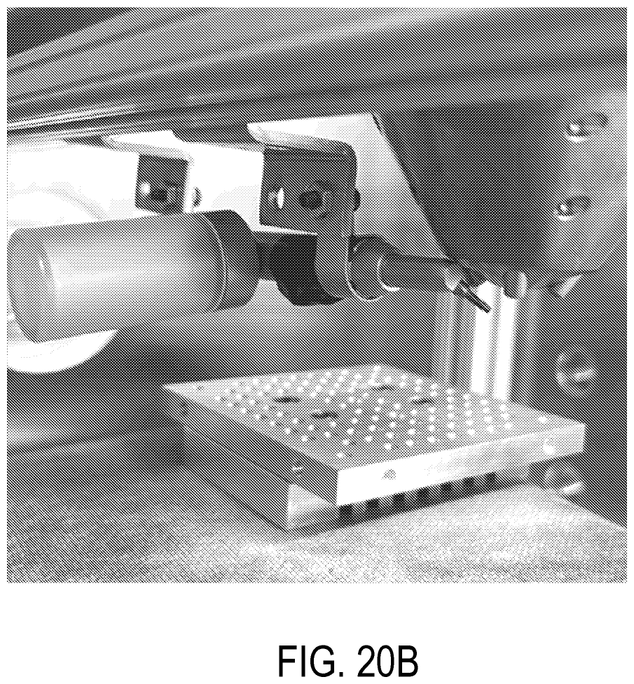

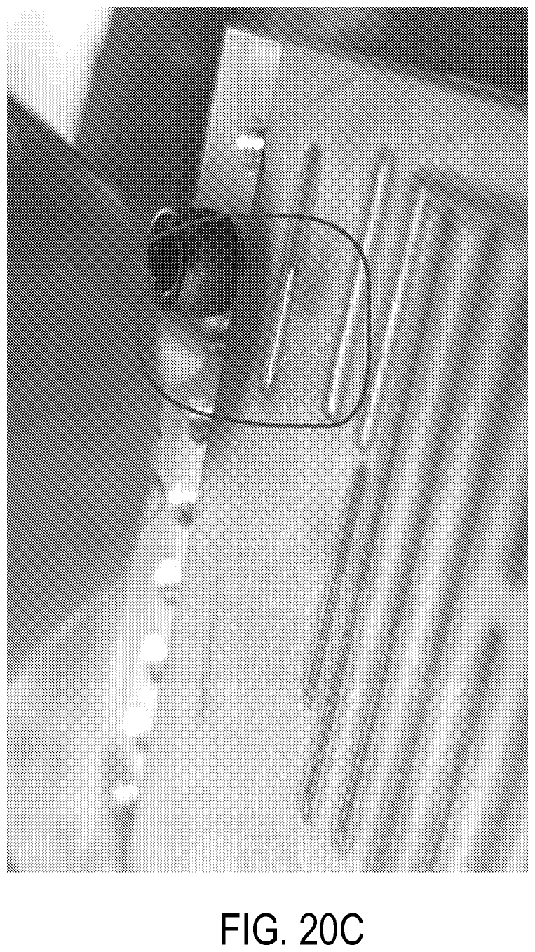

Turning to FIG. 17, a front view of another embodiment of an additive manufacturing system is shown. Certain components from the embodiment of FIG. 16 are also used in the embodiment of FIG. 17. As shown, the system 200 includes an integrated deposition head 202 that has a primary nozzle portion 204, and an energy nozzle portion 206. The primary nozzle portion 204 is connected to a material feed system and delivers the material, while the energy nozzle portion 206, connected to an energy source 112, delivers the energy for melting the material as it contacts the part 106. The system 200 further includes a frame portion 208 to which the integrated nozzle 202 may be mounted along with one or more magnets 118. In the current embodiment, the frame portion 208 has a spherical zone shape, however, it will be understood that the shape of the frame portion may be designed according to the desired characteristics of the applied magnetic field. Also, while six magnets 118 are shown, it will be understood that any number of magnets may be mounted to the frame portion 208. In FIG. 17, the energy source 112 is connected to the integrated deposition head 202 and, in the current embodiment, supplies a coaxial energy beam 114 from the energy source 112 to melt the particle stream 104 supplied by the primary nozzle portion 204.

In some embodiments, the system 100 further include one or more auxiliary powder nozzles 121 arranged to direct an additive powder stream 120 at the melt pool 116. In some embodiments, the one or more auxiliary powder nozzles 121 are separate and spaced apart from the deposition head 102. In some embodiments, the one or more auxiliary powder nozzles 121 are sized to deliver a stream of single additive powder particles to the melt pool.

The DED systems described herein utilize focused energy (e.g., an electron beam or laser beam) to fuse materials by melting as the material is being deposited. Powder feedstock can be utilized with the DED processes described herein. As discussed above, the powder can be delivered through a nozzle, with the powder melted by a laser beam on the surface of the part.

The powder may comprise any suitable metal or combination of metals. In some examples, the powder can comprise, for example, an aluminum alloy, a steel alloy, a nickel alloy, a titanium alloy, a copper alloy, and combinations thereof, without limitation. In some embodiments, aluminum is present in a concentration from about 0.1 wt % to about 90 wt %. In some embodiments, copper is present in a concentration from about 0.1 wt % to about 90 wt %. In these or other embodiments, magnesium is present in a concentration from about 0.1 wt % to about 90 wt %. In these or other embodiments, at least one of zinc or silicon is present in a concentration from about 0.1 wt % to about 90 wt %. In some embodiments, the metal alloy further comprises chromium. In some embodiments, scandium is not present in the metal alloy. In some embodiments, the powder can comprise a nickel-chromium alloy, such as an Inconel alloy.

In some embodiments, the powder may comprise one or more metals selected from the group consisting of Al, Si, Fe, Cu, Ni, Mn, Mg, Cr, Zn, V, Ti, Bi, Ga, Pb, or Zr. Other metals/elements may be included in the powder, such as (but not limited to) H, Li, Be, B, C, N, O, F, Na, P, S, Cl, K, Ca, Sc, Co, Zn, Ga, Ge, As, Se, Br, Rb, Sr, Y, Nb, Mo, Tc, Ru, Rh, Pd, Ag, Cd, In, Sn, Te, I, Cs, Ba, Hf, Ta, W, Re, Os, Ir, Pt, Au, Hg, Tl, Ce, Nd, and combinations thereof. In some embodiments, the powder can comprise a magnetic metal or alloy. In some embodiments, the powder can comprise a ferromagnetic metal or alloy.

The additive powder stream can comprise any suitable alloying elements, such as materials known to function as grain refiners, as strength enhancers, as stability enhancers, or a combination thereof. In some embodiments, the additive powder can comprise grain-refining nanoparticles or microparticles, such as Al₃Zr, Al₃Ta, Al₃Nb, Al₃Ti, TiB, TiB₂, SiC, WC, AlB, or combinations thereof. Other suitable additive particles include zirconium, tantalum, niobium, titanium, or oxides, nitrides, hydrides, carbides, or borides thereof.

### EXAMPLES

To further illustrate the principles of the present disclosure, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their disclosure. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1: Hybrid Additive Manufacturing of Inconel 718 Heat Exchangers for High-Temperature, Hydrogen Environments

Described herein are systems and methods for additive manufacturing. These systems and methods can be used, for example, for the fabrication of Inconel 718 heat exchangers with complex micro-channels and other components for clean hydrogen in thermal and chemical systems. These heat exchangers are exposed to high temperatures and hydrogen attack that can cause premature degradation and failure of the nickel superalloy. Creep testing can be conducted to evaluate the performance of the additive-manufactured Inconel 718 in harsh conditions, including exposure to high temperature and during hydrogen attack.

The systems and methods for additive manufacturing can include modified directed energy deposition (DED) system (e.g., laser-based and/or powder-blown DED) that includes an applied magnetic field within the melt pool, an auxiliary powder nozzle arranged to deliver an additive powder to the melt pool, or a combination thereof. In some examples, the hybrid additive manufacturing process can utilize an auxiliary powder nozzle that injects ceramic and/or Inconel 718 particles into a metallic Inconel 718 melt pool for tunable composition and grain nucleation. In some examples, the hybrid additive manufacturing process can comprise a laser-based and powder-blown directed energy deposition (DED) metal additive manufacturing process with a surrounding static magnetic field present within the melt pool. In some cases, in-process monitoring can be used to visualize changes in the melt pool in real-time.

Based on the laser-based powder-blown DED process, the additive manufacturing portion can utilize various deposition nozzles with different flow rates and gas pressures for the deposition and melting of dissimilar materials and feedstock powder particles. For a metal matrix material in this example, the substrate can be the Inconel 718 nickel superalloy, with differing sizes of IN718 particles deposited for the varying resolutions of microchannels and in complex inner geometries. Silicon carbide ceramic particles can be deposited separately and injected with greater velocities onto a heated IN718 underlayer for increased hardness and protection from harsh conditions.

The additive manufacturing processes described herein can be distinguished from many conventional DED methods by the use of multiple nozzles for deposition and/or the control of the underlying melt pool. The incorporation of a static magnetic field can control the melt pool fluid flow by altering the Marangoni effect with the Lorentz force. The incorporation of a static magnetic field can also control the melt pool dimensions. This is like beam shaping, but a magnetic field also has the added benefit of controlling the fluid flow directions in the melt pool, as well as modifying the mechanisms of solidification for refined grain structure. Grain refinement can also be achieved with the injection of the small SiC ceramic particles that will also not only serve as reinforcement particles and strengthening coating component, but can be areas for grain nucleation when deposited, or injected, into the bottom of the melt pool. An auxiliary nozzle can be used to inject the ceramic particles at desired depths into the melt pool by changing the gas pressure, which also modifies the particle velocity, allowing the particles to break the surface energy of the high surface tension melt pool. The combination of a magnetic field (which will set the correct conditions for melt pool flow) and tunable nozzle parameters can allow for controlled locations and grain nucleation of particle deposition. In general, the hybrid process can be two-fold-there can be control of the melt pool fluid flow and grain refinement during solidification that can not only give grain refinement due to turbulent flow as well as a decrease in porosity formation but can also prepare the melt pool for the injection of ceramic particles.

After characterization and testing of the additive manufactured parts, convolutional neural network transfer learning algorithms based on the process monitoring images can link the tunable process parameters of laser energy, laser power, scan speed, powder particle deposition rates, and magnetic field with the results of microstructure characterization (including grain size, phases, and porosity) and mechanical testing. Because process parameters are not universal across machines, real time imaging that shows process physics can allow us to bridge the relationships between the process and performance when manufacturing builds, such as the example Inconel 718 heat exchanger components. The systems and methods described herein can address manufacturing challenges by its tunability in real time, and well as the hybrid manufacturing capabilities of magnetic field, controlled injection and deposition of powder particles, and the process monitoring with machine learning.

Inconel 718 is utilized in additive manufacturing; however, there are many issues with its microstructure, including intermetallic phases and undesirable precipitation, which include the detrimental delta phase for additive manufactured Inconel 718 components. There have been efforts to control the thermal history of the localized areas for Inconel, and therefore controlling their microstructure. Even though the DED process is great for its high deposition rates and for larger parts, DED tends to result in large columnar grains and large grains that span layers due to heat accumulation. In addition, metal additive manufacturing processes face the challenge of controlling microstructure and grain size, leading to embrittlement or even a decrease in strength. Most metal additive manufacturing still face challenges in understanding porosity formation and controlling the porosity of builds. Other notable challenges include the inability to tune chemical composition instantaneously in real time as well as tune the laser power or laser scan speed instantaneously within the same layer, especially when certain boundaries of the geometric design can modify the microstructure substantially.

The printing of high-temperature, harsh materials has also been a challenge. Typically, binder jetting or a multi-step sintering processes can print refractory powder particles that can withstand hydrogen embrittlement or hydrogen or harsh environments. However, binder jetting does not allow for complicated geometries, such as microchannels, or tunable material composition during each layer, let alone within the entire component. The DED process allows for: 1) high rate of deposition and ability to print large parts; 2) five degrees of freedom by adding two rotary axes more complex geometries, especially inner channels or curved parts and without the use of support structures which require extra time and production; and 3) material tunability in real time, with each layer or even more localized than that-where in very localized areas of the part can have very different chemical composition and material properties.

The as-processed micro and macro structure of additively manufactured IN718 presents several challenges that prevent its widespread use in many applications including: hard to remove defects, porosity, a strong crystallographic texture that leads to an anisotropic mechanical response, the presence of residual stresses, and micro segregation of alloying elements. These characteristics can have a significant influence on the fatigue behavior (crack initiation, crack growth rates, etc.) at elevated temperatures and in hydrogen-prone environments causing a significant reduction in fatigue lifetime. To date, there is little understanding of the correlation between the micro and macro structural heterogeneity after processing and the material's response during mechanical loading. To understand the microstructural evolution during additively manufacturing of IN718, this aim will use specifically designed characterization techniques that employ multi-modal experiments across multiple length scales. The experimental data will provide information on the underlying mechanisms that control mechanical behavior in these materials. The combination of scanning electron microscopy (SEM), electron back scatter diffraction (EBSD), and electron channeling contrast imaging (ECCI) will be used to understand the evolution of dislocation structures, distribution of secondary phases, and crystallographic texture immediately following solidification. The combination of transmission electron microscopy (TEM) and energy dispersive spectroscopy (EDS) will be used to characterize dislocation interactions with strengthening phases (i.e. coherent γ″) and their arrangement throughout the microstructure as well as micro segregation of alloying elements. Microcomputed tomography (lab-based) and SEM will be used to quantify the morphology, distribution, and size of defects (i.e. pores) immediately following processing. Gaseous hydrogen charging of the additively manufactured Inconel 718 will be used to emulate the real operational conditions of a heat exchanger for hydrogen. Specifically, hydrogen charging in a lab-scale pressure vessel will be done from the gas phase at 300~700° C. and 1~10 atm for 100 hours, followed by ageing at room temperature; additionally, thermogravimetric analyzer (TGA) will be used to treat the alloy material with pure hydrogen environment at 1 atm up to 800° C. where we can monitor materials mass evolution during the hydrogen charging. To understand the chemical interaction of hydrogen with the alloy during the above hydrogen charging processes, we will measure the evolved gas composition by mass spectrometer and gas chromatography, and potential chemical reaction products include methane and water vapor. After the charging step, we plan to conduct temperature programmed desorption of hydrogen to quantify the amount of hydrogen absorbed by alloy material sample. Furthermore, the co-existence of hydrogen and water vapor is common in thermal and chemical systems. In such a situation, water vapor tends to oxidize the alloy material while hydrogen tends to reduce the alloy material. Therefore, water vapor gives additional mechanisms for alloy material degradation. This motivates us to conduct another set of gaseous hydrogen charging with water vapor at mole fractions between 0.01% and 3%.

Creep-fatigue interaction is complicated due to the difference in the applied load that drives each deformation mode, but also by the spatial distribution of creep and fatigue-related damages and how they interact. Creep damage is distributed on the specimen length scale, occupying a large process zone, and drives intra and intergranular micro-void formation and growth, grain boundary sliding, and is enhanced by microstructural aging processes (precipitate formation and coarsening, etc.). Fatigue is localized with the process zone coalesced around persistent slip bands, and ultimately the crack initiation sites or crack tip. Nucleation is sensitive to microstructure and environment (pre-existing defects, surface treatment, oxidation, starting dislocation structure) while crack propagation mechanisms depend more on load history, grain and grain-boundary strength, and residual stresses. Creep and fatigue degradation mechanisms do not evolve temporally or spatially in sync with each other. The question becomes, can something be gleaned about creep-fatigue interaction by monitoring the spatial evolution of strain and strain-energy-dissipation fields during testing? In this study, the spatial evolution of these fields shall be tracked to capture (a) gross creep deformation and localized fatigue cracking and (b) the evolution and interaction of these processes from initiation to rupture/fracture. The 3D DIC and IR imaging technology will be used for creep-fatigue testing of the additive manufactured Inconel 718 specimens after and while they undergo the harsh conditions of elevated temperatures and a hydrogen attack. The spatial strain and temperature data will be post-processed to furnish strain-energy-dissipation fields and using the HITL-ML model, creep, fatigue, and creep-fatigue damage fields will be produced. An analysis of the spatial evolution of these fields will offer for the first time an observation of the spatial evolution of creep-fatigue damage and hopefully a new understanding of creep-fatigue interaction.

The systems and methods described herein will not only influence the way hybrid manufacturing can tackle materials development challenges and pave the way for materials discovery but will also allow for fewer steps in the process and control for microstructure instead of allowing the large thermal gradients and heat accumulation to dictate the large columnar structures seen in most additive manufactured parts. With fewer steps in the manufacturing process and by using less feedstock materials as compared to most metal additive manufacturing processes, the proposed hybrid process will have a smaller carbon footprint and emit less greenhouse gases. In addition, the longer lifespan of the Inconel 718-SiC components at elevated temperatures and with hydrogen exposure will decrease the carbon footprint and increase efficiency of such components. With more efficient and longer-lasting heat exchangers, a carbon-free future and energy supply becomes closer to a reality. The metrics and performance will be evaluated with deposition rate during manufacturing, life cycle analysis, carbon emissions, microstructure characterization, and fatigue life. The technical risks involved in the process include the complexity of capturing the various process physics with laser powder-blown metal additive manufacturing, including a vapor plume, entrainment of particles, and spattering-which could increase the roughness of the microchannels. However, process monitoring will allow for control of the gas flow and process in real-time.

### Background and Project Goals

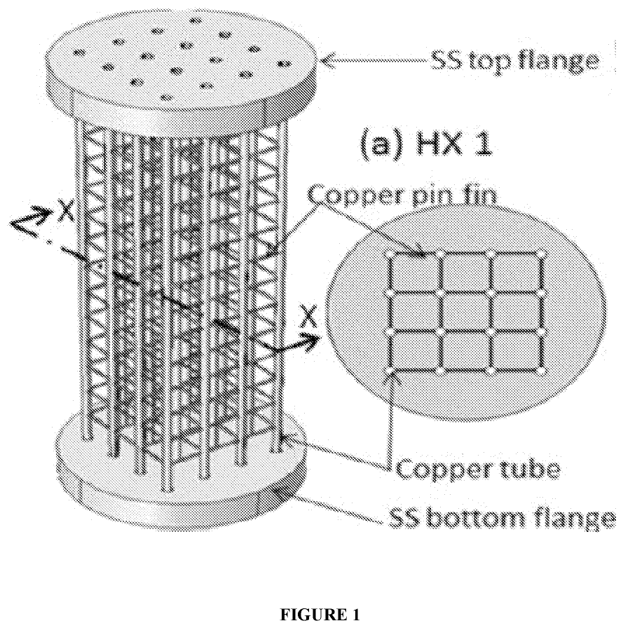

The hydrogen economy is imminent with growing needs for decarbonizing industry and alternative energy sources. OEMs such as GE have demonstrated flexible hydrogen gas turbines and Rolls-Royce has ground tested an existing commercially flown jet engine with hydrogen to decarbonize air travel. Needs in hydrogen storage systems also require reactors with heat exchangers that can withstand high temperatures and hydrogen attack, with an example illustrated in FIG. 1. Additive manufacturing (AM) can improve the performance of heat exchangers by printing complex geometries. To enable the hydrogen economy, improved structures and materials must be engineered that can survive the harsh environments of hydrogen attack and the enhanced risk of creep and creep-fatigue cracking. Heat exchangers are particularly sensitive to these failure modes.

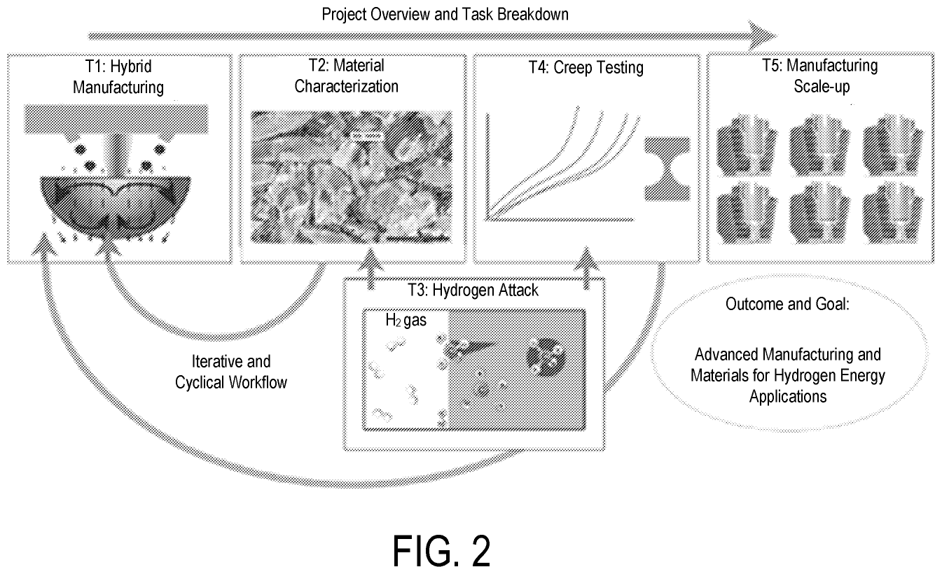

A goal of this work is to develop systems and methods of AM that can improve printability, microstructure, hydrogen resilience, and mechanical performance of additive manufactured Inconel 718 metal matrix composites (AM IN718 MMCs) for heat exchangers. As shown in FIG. 2, the proposed work will leverage additive manufacturing processing techniques, hydrogen testing, and accelerated mechanical tests to understand the entire lifespan and performance of AM components that will undergo harsh hydrogen attack conditions. The scope of this work focuses on the manufacturing of components and their resulting characteristics when subjected to high-temperature hydrogen conditions, which have not been studied in-depth.

### Technical Description and Impact

The systems and methods described herein can be used for the fabrication of IN718 MMC heat exchangers with complex micro-channels for clean hydrogen production and storage in thermal and chemical systems. These heat exchangers can be exposed to high temperatures and hydrogen attack that can cause premature degradation and failure of the nickel superalloy. Hot and pressurized hydrogen testing will be performed to evaluate hydrogen uptake and microstructural degradation due to hydrogen attack. Pre-and post-exposure tensile, creep, and creep-fatigue testing will be conducted to evaluate the resistance and structural integrity of the additive manufactured IN718 MMCs in harsh conditions.

The overall approach to the proposed work and advancing the technology is a cyclical manufacturing, validation, and testing methodology (shown in FIG. 2), where after each cycle, iterative improvements are made to the hybrid manufacturing process as new knowledge is gained. Validation and testing are planned with in-depth microstructure characterization, testing the components under simulated hydrogen environments, and creep testing.

Direct outcomes from this work include homogenous AM components with multiple scales of resolution, reduced production cost, improved microstructure, improved material performance, and increased component lifetime.

### Hybrid Additive Manufacturing

Described herein are systems and methods for hybrid additive manufacturing that inject ceramic and IN718 particles into a metallic IN718 melt pool for tunable composition, grain nucleation, and for the formation of secondary phases that are resistant to degradation in harsh environments. The hybrid process can include laser-based powder-blown directed energy deposition (DED) metal additive manufacturing, an external magnetic field, multiple nozzles, and process monitoring to visualize changes in the melt pool in real-time.

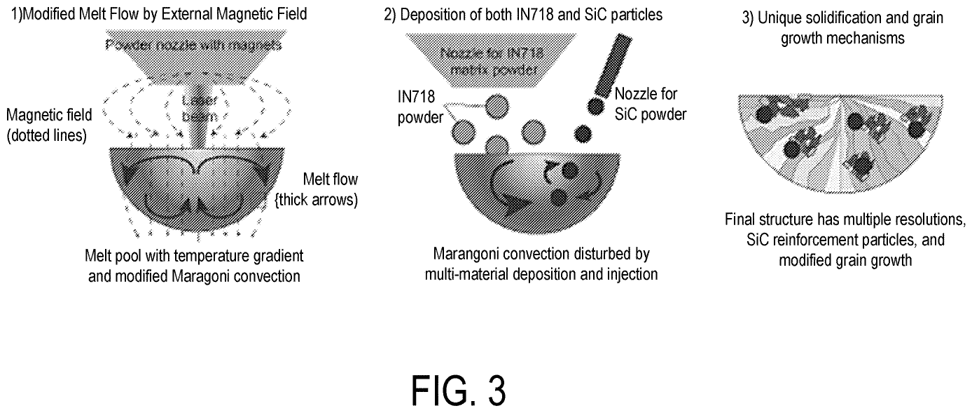

As shown in FIG. 3, multiple powder particle nozzles with different flow rates and gas pressures can be used to deposit a multi-material feedstock into the underlying melt pool. For the MMC component, the substrate is the IN718 nickel superalloy, with differing sizes of IN718 particles deposited on the melt pool surface for varying resolutions of microchannels and complex inner geometries. Silicon carbide (SiC) ceramic particles can be deposited from a secondary (auxiliary) nozzle and injected with greater velocities to break the melt pool surface energy barrier of the underlying melt pool and to tune microstructure and performance. Varying process parameters and compositions of the IN718 MMC will be explored in a systematic design of experiments. These parameters will later link to in situ process data, microstructure data, hydrogen testing parameters, and mechanical performance.

In some cases, the system and method cam employ both multiple nozzles for deposition and a magnetic field for melt pool control. First, an external static magnetic field can control the melt pool fluid flow directions and melt pool size by altering the Marangoni effect with the Lorentz force. Magnetic control can alter the mechanisms of solidification for refined grain structure by introducing thermoelectric-induced turbulence where nucleation occurs at the solid-liquid boundaries of the melt pool. Second, there is further grain refinement with the injection of the small SiC particles that not only serve as reinforcement particles and a strengthening coating component, but can be areas for grain nucleation when deposited, or injected, into the bottom of the melt pool. SiC particles can lead to carbon-rich dislocations and grain boundaries, acting as sites to trap hydrogen and prevent embrittlement. The secondary nozzle injects the ceramic particles at desired depths into the melt pool by modifying carrier gas pressure and velocity, allowing the particles to break the surface energy of the high surface tension melt pool. The combination of a magnetic field and tunable nozzle parameters allow for controlled, localized microstructure. The hybrid process is two-fold-there is grain refinement and reduced porosity by controlling fluid flow, as well as a preparation of the melt pool for the injection of SiC particles.

In situ process monitoring with high-speed optical and thermal imaging captures the real-time changes in melt pool flow and surface tension. Synchrotron beamtime can also be used to visualize the melt pool changes at the cross-section. Convolutional neural network transfer learning can use these process images and correlate the tunable process parameters of laser power, scan speed, powder deposition rates, and/or magnetic field with the results of microstructure characterization (including grain size, phases, and porosity) and mechanical testing. Because process parameters are not universal across machines, real-time imaging that shows process physics is essential to bridge process to performance of the IN718 MMC heat exchanger components. The proposed technology will quantify these process-structure-property-performance relationships by its hybrid AM capability, tunability in real time, and data collection and use of machine learning and data analytics.

The methods and systems described herein can generate high resolution geometrical features with the magnetic field, as the DED process is typically coarser than laser powder bed fusion, and in reduced production cost because of the use of nozzles to deposit powder instead of using a powder bed and without using post-processing techniques.

While IN718 has been used in AM, challenges arise with rapid solidification, including intermetallic phases, undesirable precipitation, which include the detrimental delta phase for AM IN718 components. There have been efforts to control the thermal history of the localized areas for Inconel, and therefore controlling their microstructure. Even though the DED process is an ideal AM process for its high deposition rates for large, industrial-grade components, the high heat input and accumulation result in large columnar grains that span multiple layers. These challenges are exacerbated by the inability to tune chemical composition or laser power instantaneously in real-time, especially when certain boundaries of the geometric design can modify the microstructure substantially. In general, metal AM processes face the challenge of controlling microstructure and grain size, leading to embrittlement or even a decrease in strength. Most metal AM processes also face qualification and validation challenges in the understanding and control of porosity formation.

Although topology-optimized heat exchangers are best fabricated with AM processes, printing materials like MMCs that can withstand harsh environments is a challenge. Binder jetting AM or a multi-step sintering process can print refractory materials that can withstand high temperatures and hydrogen embrittlement. However, these AM processes have limitations in the inability to 1) fully fuse particles together, resulting in less desirable mechanical performance and 2) to tune material composition in real-time. The DED process's advantages are 1) high rate of deposition and ability to print large parts; 2) five degrees of freedom in motion for complex geometries, especially internal channels, or curved parts and without the use of support structures; and 3) material tunability in real-time at localized areas of the printed component.

Both the feasibility of using a magnetic field to modify (and potentially control) laser-induced melt pool flow as well as manipulating powder deposition to fabricate metal matrix composites have been demonstrated using in situ and operando high-speed synchrotron X-ray imaging of the DED AM process.

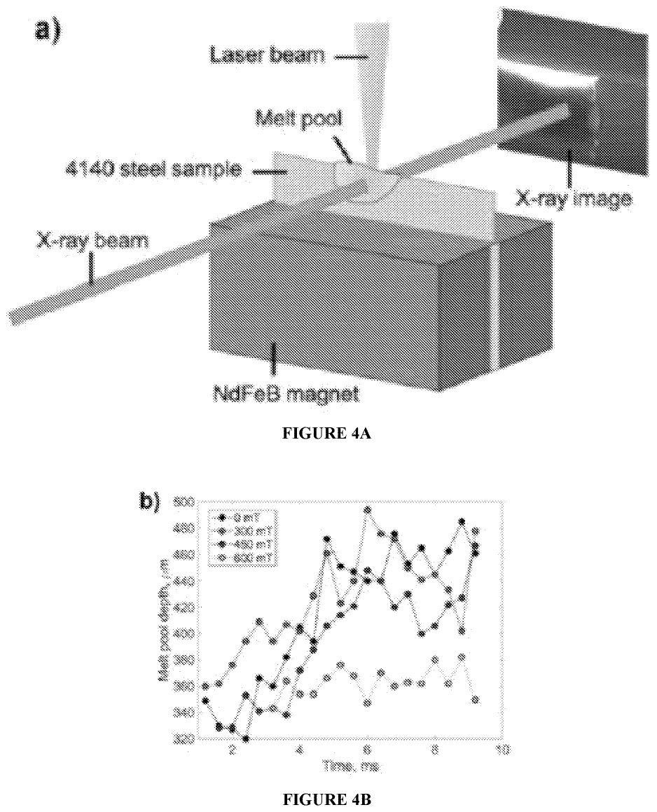

Magnetic field control of the melt pool: Preliminary work has been conducted in two sets of experiments: 1) proof-of-concept experiments to investigate whether there were more meso-scale changes to melt pool geometry with a magnetic field (FIGS. 4A-4B), and 2) to evaluate the melt pool flow velocities in different areas of the melt pool using tungsten tracer particles. In both sets of experiments, an operando system was used at the 32-ID beamline at the Advanced Photon Source (APS) at Argonne National Laboratory.

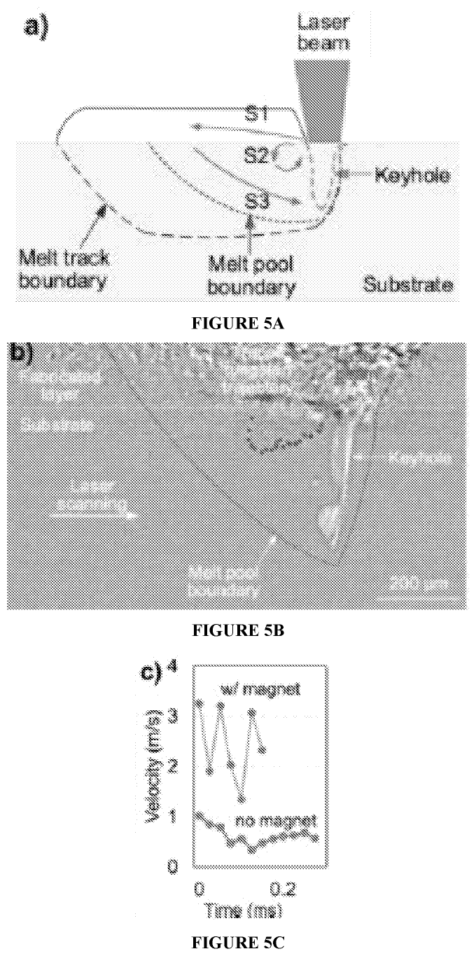

Changes in melt pool depth were measured (FIG. 4B), with a decrease with a magnetic field strength of 600 mT, most likely indicating a decrease in the recoil pressure at the keyhole with the magnetic field. With greater magnetic field strengths, flow velocities decreased, indicating dampening of Marangoni convection. Similar experiments conducted with 316L stainless steel and tungsten tracer particles showed changes in melt pool velocities (FIGS. 5A-5C). With a magnetic field, there was a dramatic increase in flow velocity magnitude and fluctuation.

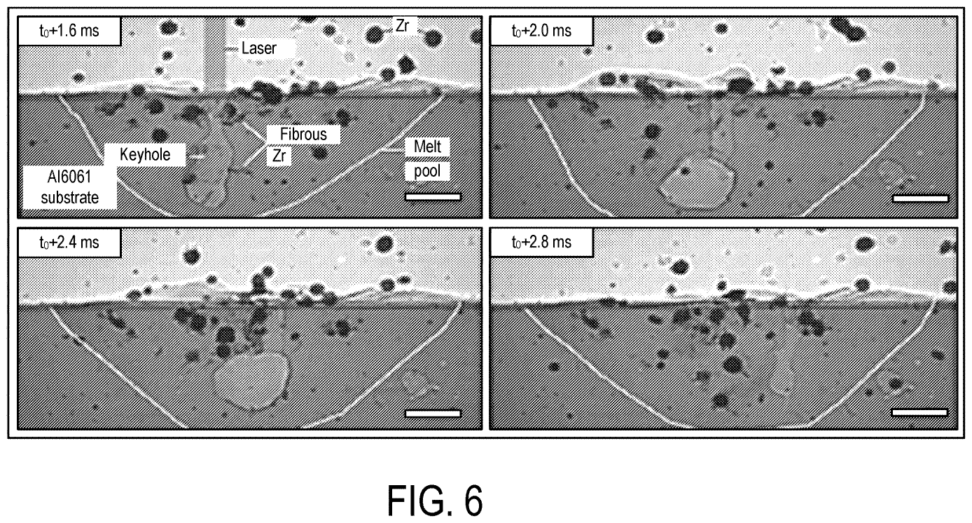

DED Processing of MMC: Proof-of-concept in situ imaging experiments of the DED process at APS used controlled powder flow rates of various oxides and differing elements into both aluminum and titanium alloy substrates. Reinforcement particle deposition resulted in particles wetting on the melt pool surface and only partially melting, or particles injected into the melt pool to create a network of reinforcement particles with partially melted phases at solidification. The key parameters in how these particles interacted with the melt pool was the controlled argon carrier gas flow rate and velocities of the deposited particles into the melt pool, varying kinetic energy of the particles relative to the surface energy of the melt pool. FIG. 6 shows zirconium, Zr, particles entering a laser-induced molten pool within an aluminum Al6061 substrate. Within a few milliseconds, the Zr mixes within the melt pool for a more uniform distribution of particles. This work demonstrated the feasibility of a MMC with a reinforcement network. Machine learning techniques using data collected in real-time have also been used to link process to structure. Convolutional neural networks of images collected with in situ high-WO speed synchrotron imaging were used to predict porosity and to correlate porosity with processing conditions.

### Material Characterization

The as-processed micro and macro structure of additively manufactured IN718 presents several challenges that prevent its widespread use in many applications including: hard to remove defects, porosity, a strong crystallographic texture that leads to an anisotropic mechanical response, the presence of residual stresses, and micro segregation of alloying elements. These macro and microstructures strongly influence the mechanical behavior including both creep and fatigue resistance. Specifically, the submicron cell structures as well as phases such as δ-phase at the grain boundaries have both been reported to have varying effects on this behavior. To date, there is little understanding of the correlation between the micro and macro structural heterogeneity after processing and the material's response during mechanical loading.

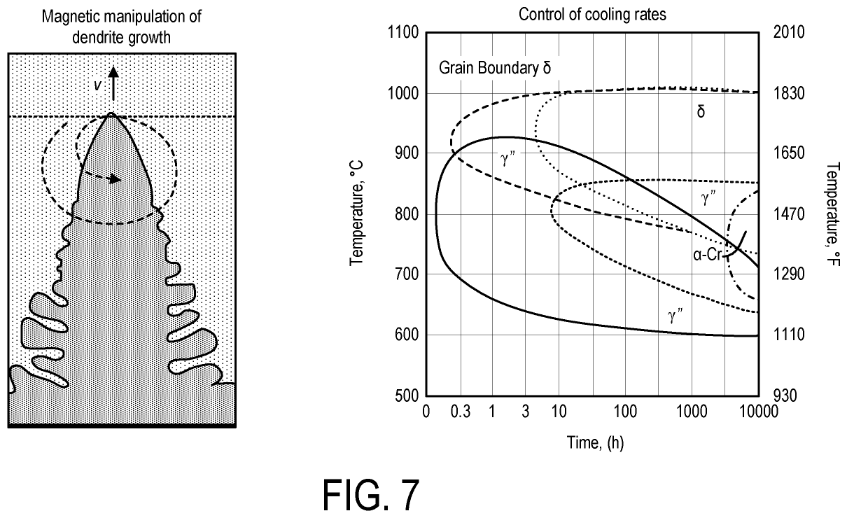

To understand the microstructural evolution in IN718 during additive manufacturing as shown in FIGS. 3 and 7, we will use a workflow combining scanning electron microscopy (SEM), electron channeling contrast imaging (ECCI), electron back scatter diffraction (EBSD), scanning transmission electron microscopy (S/TEM) and micro X-ray computed tomography (XCT) to: (1) understand the influence of processing strategy on microstructure (i.e., grain size, morphology, crystallographic orientation, phase formation) as well as porosity and void formation (FIG. 7), (2) understand the evolution of the microstructure during subsequent heat treatments, and (3) connect the underlying micro and macro structure (i.e., as-built, heat-treated, etc.) to the micromechanical response (i.e., creep, fatigue) by uncovering individual micro scale dislocation interactions.

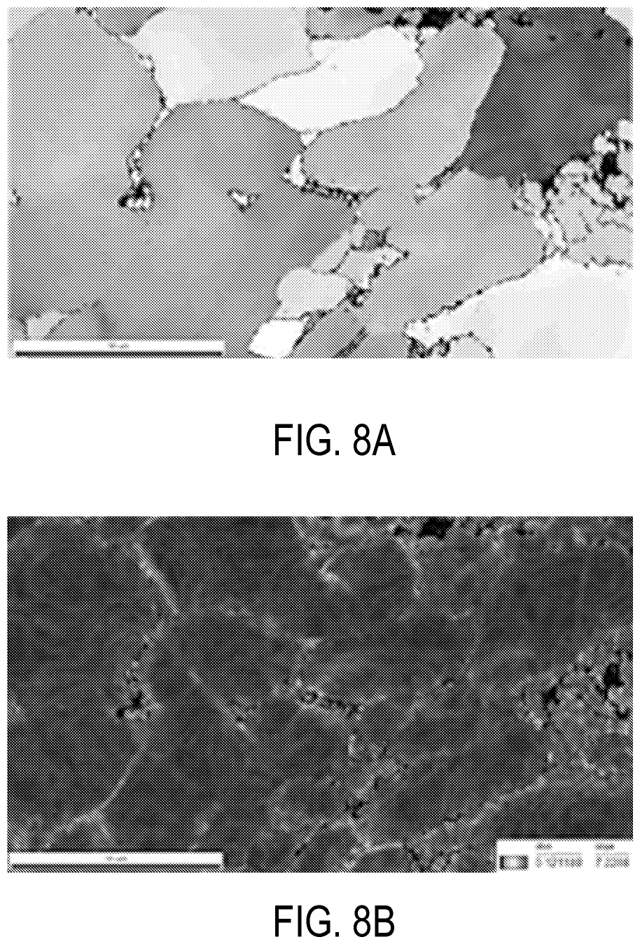

The experimental data will provide information on the underlying mechanisms that control mechanical behavior in these materials. SEM Imaging will be used to quantify grain size and morphology as well as the distribution of phases throughout the microstructure. SEM imaging will also be used to understand defect (i.e., pores, voids, etc.) structure and distribution in relation to the microstructure. In addition, this information will be used to link the micro and macro structure to the DED processing strategy. SEM-EBSD is an effective 2D surface technique for calculating the local crystallographic orientation, distribution of phases, and grain size and morphology of a material. Since EBSD measures the local crystallographic orientation, it can be used to determine deviations in the local orientation because of plastic deformation during creep and fatigue. To further investigate plasticity throughout the microstructure the kernel average misorientation (KAM) method will be used to locate regions of high dislocation density. KAM uses EBSD orientation data to measure local misorientations across the microstructure by calculating the average misorientation around a single point based on a defined set of nearest neighbor points. Since dislocations cause lattice rotations, areas that contain dislocations will have a higher misorientation than regions with little to no dislocations. As a result, KAM can be used to identify relationships between strain localization and the microstructure. From the KAM analysis, color-coded maps (FIGS. 8A-8B) are generated where a range of misorientation angles are represented by specific colors. FIGS. 8A-8B show the accumulation of plastic deformation in regions containing precipitates and along grain boundaries of an AM Cu based alloy produced following tensile deformation.

To understand the underlying dislocation structures and arrangements (i.e., dislocation pileups) within the microstructure ECCI will be performed on as-built and deformed samples. Electron channeling patterns will be collected using the state-of-the art no-tilt, Timepix ECCI, the combination of S/TEM and energy dispersive spectroscopy (EDS) will be used to characterize dislocation interactions with strengthening phases (i.e., coherent γ″, δ-phase) and their arrangement throughout the microstructure as well as micro segregation of alloying elements. Microcomputed tomography (lab-based) and SEM will be used to quantify the morphology, distribution, and size of defects (i.e., pores) immediately following processing as well as the structure of cracks and other defects following mechanical testing.

This material characterization can allow us to quantify the multi-scale differences in phase transformation changes, grain size, orientation, porosity, and dislocations with conventional DED and the proposed hybrid DED process, before and after hydrogen attack, and before and after creep testing.

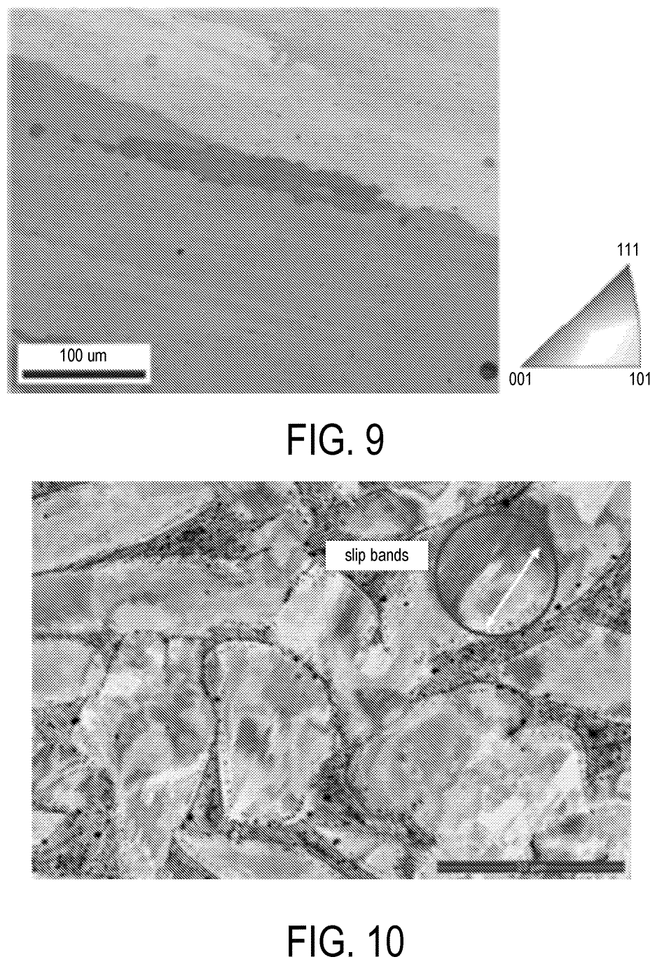

The micro and macro structures of additively manufactured materials are usually very different than those that are traditionally manufactured. Previous work on a similar alloy, IN625, produced via DED AM showed elongated grains along the <001> crystallographic direction, as shown in the EBSD-inverse pole figure map in FIG. 9. Second phase particles (precipitates) and small spherical pores were also observed. This information led to understanding the influence of the microstructure, second phases, and porosity on tensile behavior in IN625. EBSD is effective in correlating texture to dislocation slip behavior in complex additively manufactured alloys. Other work included mapping strain stored as dislocations, which were localized along grain boundaries and within interdendritic regions with several types of second phase particles.

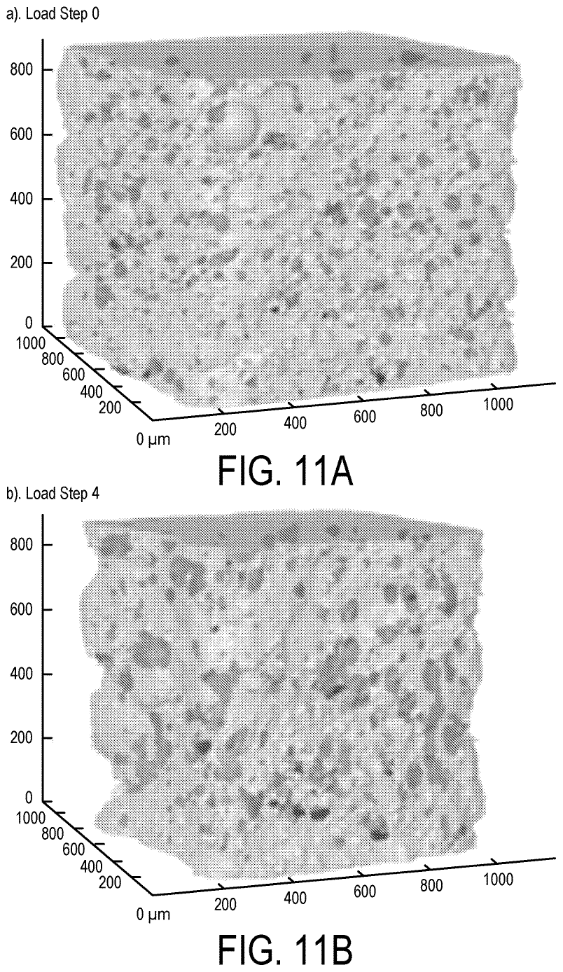

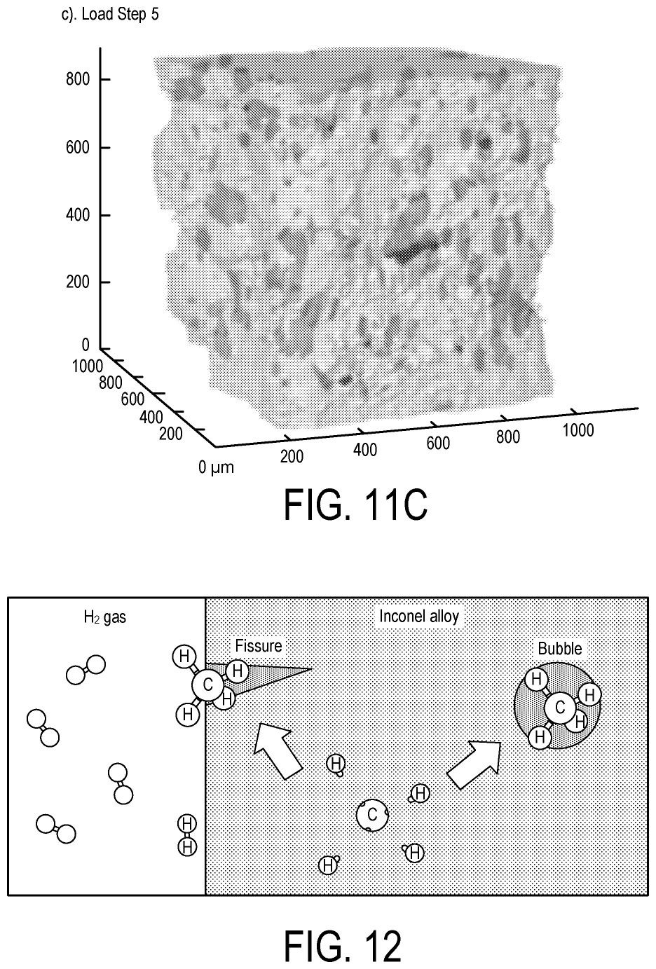

In addition to EBSD, ECCI is effective for visualizing underlying dislocation structures and arrangements (i.e., dislocation pileups). ECCI will be performed on as-built and deformed samples. Dislocation slip bands within grains in an AM nickel-aluminum bronze alloy using ECCI is shown in FIG. 10. This analysis provides site specific information on strain localization to understand dislocation interactions in the microstructure using S/TEM. The previously discussed 2D techniques provide valuable information on microstructure but cannot quantify the shape and morphology of defects such as pores and cracks. Techniques such as XCT enable 3D characterization of pores and how these pores evolve during AM and post treatments and mechanical testing. An example of 3D XCT reconstructions of damage evolution from asymmetric pores during in-situ tensile loading is shown in FIGS. 11A-11C.

### Hydrogen Testing

Mechanical property deterioration of metals by hydrogen is broadly referred to as hydrogen damage. It mainly includes hydrogen embrittlement (HE, typically below 100° C. and reversible) and high temperature hydrogen attack (HTHA, usually irreversible). HTHA involves a chemical reaction between hydrogen and metal/alloy compositions such as carbide, forming insoluble gas molecules such as methane (CH₄); such a reaction doesn't occur in HE. Proposed testing will focus on HTHA and includes charging of AM IN718 MMCs to emulate the real operational conditions of a heat exchanger for hydrogen. The temperature and pressure ranges can be selected to cover both the present and the future's hydrogen related industrial high temperature processes such as steam methane reforming and H₂-based steel making.

Hydrogen testing includes using gaseous hydrogen charging as closely as possible to simulate the application of a hydrogen heat exchanger in practice. Specifically, hydrogen charging of an AM IN718 specimen will be done in a lab-scale high pressure high temperature vessel from the gas phase at conditions relevant to industrial heat exchanger, ranging 300 to 800° C. and 1 to 20 atm, for up to 200 hours, followed by ageing at room temperature. Besides, a thermogravimetric analyzer (TGA) will be used to treat the AM IN718 MMC alloy material with a pure hydrogen environment at 1 atm up to 1000° C. to monitor the material's mass evolution during hydrogen charging. After the above hydrogen charging processes, temperature programmed desorption of hydrogen and gas products from HTHA will be conducted.

To understand the chemical interaction of hydrogen with the AM IN718 MMC during the above hydrogen charging and desorption processes, we will measure the evolved gas composition by mass spectrometer and gas chromatography where the potential chemical reaction products include methane. These are realized as physical features such as fissures and bubbles in the IN718 alloy, which could result in premature degradation and failure due to hydrogen attack, as seen in FIG. 12. Specifically, the H2 molecule dissociates into small H atoms that enter the IN718 alloy lattice, preferably residing at a grain boundary, dislocation, or carbide secondary phase. Then the hydrogen atoms react with carbide to form methane (CH₄), which is too big to transport through the alloy crystal lattice. Therefore, the methane gas product forms bubbles inside the alloy, or fissures at the alloy surface. Since atomic hydrogen dissolved in the material can cause reversible HE, the proposed HTHA test will be performed after the specimen is degassed by baking hydrogen out in vacuum at 250° C. for 3 hours, so that the effects from the two hydrogen damage mechanisms are separated. Additionally, we will separate the effects of HTHA from other elevated temperature metallurgical damage. Therefore, the plan is to compare results of tests carried out after exposure to H2 to those after exposure to argon.

Furthermore, the co-existence of hydrogen and water vapor is common in thermal and chemical systems. For example, moisture enhances HTHA. Specifically, water vapor tends to oxidize the alloy material while hydrogen tends to reduce the alloy material. Therefore, water vapor gives additional mechanisms for alloy material corrosion/degradation, besides the reduction and overall attack shown in FIG. 12. This motivates the proposal to conduct a set of gaseous hydrogen charging with water vapor at mole fractions between 0.01% and 3% up to 6 atm, given the pressure upper limit of our water vapor generator (Cellkraft flow through humidifier).

Two main types of HTHA damage are surface decarburization and internal decarburization/fissuring. Scanning electron microscopy (SEM) will illustrate the respective level of damage via the two types above for our AM IN718 specimen. At low magnifications, SEM secondary electron imaging will show spatial distribution of fissures. At high magnifications, SEM will demonstrate fissures because of the linkage of gas bubbles along grain boundaries. Sometimes, samples without visible microstructural alterations may still fail mechanical tests. Therefore, we will complement our SEM examination with tension test, bend test, and Charpy V-notch (CVN) impact test. Along with the quantitative differences on structure, the quantitative dependence of HTHA effects on external factors of temperature, hydrogen (partial) pressure, water vapor pressure, and exposure time will be evaluated and will provide inputs to improve the proposed manufacturing process.

The AM process can increase the number of grain boundaries and dislocations in alloys, improving high temperature hydrogen attack resistance.

### Mechanical Testing

Creep-fatigue interaction is complicated due to the difference in the applied load that drives each deformation mode, but also by the spatial distribution of creep and fatigue-related damages and how they interact. Creep damage is distributed on the specimen length scale, occupying a large process zone, and drives intra and intergranular micro-void formation and growth, grain boundary sliding, and is enhanced by aging processes (precipitate formation and coarsening, etc.). Fatigue is localized in the process zone coalesced around persistent slip bands, and ultimately the crack initiation sites or crack tip. Nucleation is sensitive to structure (pre-existing defects, oxidation, starting dislocation structure) while crack propagation mechanisms depend more on load history, grain and grain-boundary strength, and residual stresses. Creep and fatigue degradation mechanisms do not evolve temporally or spatially in sync with each other. The question becomes, can monitoring the spatial evolution of strain and strain-energy-density fields during testing reveal creep-fatigue interaction?

In this example, the spatial evolution of these fields will be tracked to capture (a) gross creep deformation and localized fatigue cracking and (b) the evolution and interaction of these processes from initiation to rupture/fracture. The 3D digital image correlation (DIC) and infrared (IR) imaging technology will be used for creep-fatigue testing of the additive manufactured IN718 MMC specimens after and while they undergo the harsh conditions of elevated temperatures after hydrogen attack. The spatial strain and temperature data will be post-processed to furnish strain-energy-dissipation fields and using the HITL-ML model, creep, fatigue, and creep-fatigue damage fields will be produced. An analysis of the spatial evolution of these fields will offer for the first time an observation of the spatial evolution of creep-fatigue damage and hopefully a new understanding of creep-fatigue interaction.

Preliminary testing will be performed to gather the hot hardness and tensile (stress-strain) properties of IN1718 MMC across temperature and compare them to wrought properties. These tests screen for the basic properties of importance in stress-and strain-based design.

Accelerated creep testing before and after hydrogen attack: Creep tests will be performed on electromechanical test machines with 1200° C. furnaces with large quartz view ports for 3D-DIC. Because creep testing of high capability materials can exceed 1,000 hours, screening for AM processing and alloy optimization is a challenge and motivates the need for accelerated testing.

First, a pair of creep experiments with combinational boundary conditions will be performed: (a) the gradient stress test where the cross-section of a specimen is prepared such that a stress gradient, σ(z), exists along the gauge section; (b) the gradient temperature test where a multizone furnace is tuned to produce a stable temperature gradient, T(z) along the gauge section of uniform cross-section specimen. Measurements of the 3D thermomechanical strain fields are gathered using 3D DIC with IR thermography and blue/UV filtering of visible light. Inverse Finite Element Analysis (IFEA) using DIC data is employed to extract the thermo-mechano-creep properties across the stresses and temperatures observed in the gauge. Stress and temperature are plotted versus flow rate. Deformation mechanism transitions are detected by a change in slope. A small test matrix of 3×3 can be executed to elucidate a deformation mechanism map for each candidate IN718 MMC with varying processing conditions and gain insight into the existence and relative strength of mechanisms that drive creep.

Accelerated fatigue and creep-fatigue before and after hydrogen attack: An evaluation of the fatigue and creep-fatigue resistance shall be performed using a servo-hydraulic test machine equipped with an induction heater will perform tension tests up to 1400° C. Fatigue will be performed using a fleet of servo-hydraulic test machines at OSU equipped with 1400° C. resistance furnaces with optical view ports for 2D-DIC and a machine equipped with high frequency induction heater with an unobstructed specimen view for 2D-DIC and 3D-DIC respectively. Accelerated fatigue and creep-fatigue tests called the multi-stepped test (MST) shall be executed where block cycles of stress/strain amplitude are step increased/swept/VAL to induce rapid failure and screen for superior fatigue and creep-fatigue resistance.

The strain-energy density (SED) approach will be the benchmark by which creep and creep-fatigue resistance are screened. To extrapolate creep behavior to design-relevant times scales, final screening tests called accelerated creep tests (ACTs) will be employed. ACTs reduce the time needed to measure the creep resistance of material driven by both microstructural evolution (thermal) and deformation (mechanical) processes. To that end, dynamic negative stepped temperature/stress tests shall be performed in which specimens are kept on the edge of instability to assess their residual creep damage resistance. The boundary conditions to achieve 10,000 hours (1.2 years) of conventional creep will be calculated using the Wilshire-Cano-Stewart model calibrated to the existing creep data. The specimen will be machined with special fiducial marks such that the tests can be interrupted periodically, the specimens placed in an SEM, and microstructural evolution tracked using microstructural-scale DIC. This will enable observation and understanding of the evolution of strengthening mechanisms that contribute to survival of the best alloy. The data will be used to refine the alloy design tools and screen alloys for longer term evaluation, as described above.

We will be able to conduct high-throughput screening of a variety of IN718 MMC compositions and with varying process parameters to link processing conditions, structure to the mechanical performance (most notably creep resistance in addition to strength, fatigue, etc.) before and after hydrogen attack.

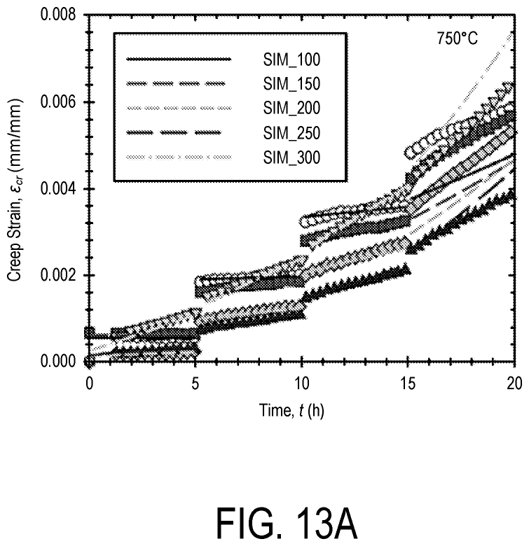

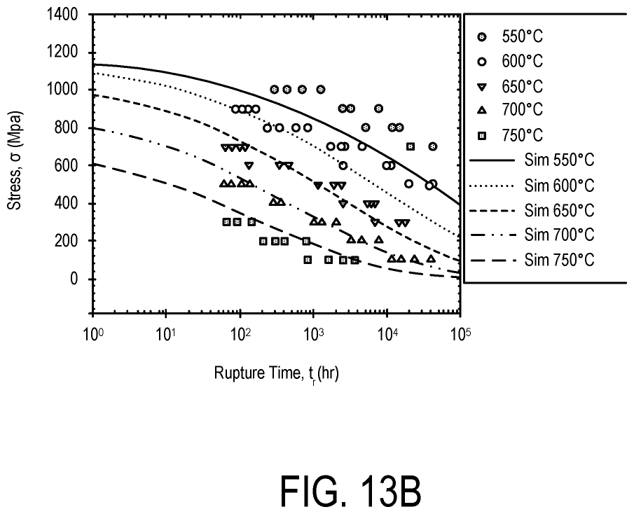

Rapid Screening for Creep Resistance: Accelerated creep tests (ACTs) for alloys based on Time-Temperature-Stress Superposition (TTSSP) theory were introduced. In TTSSP, there is a fundamental relationship between creep resistance, time, temperature, and stress that can be manipulated to reduce test duration. Two TTSSP-based tests were designed: the stepped isostress method (SSM) and stepped isothermal method (SIM), where stress or temperature are step increased until rupture, respectively. The SSM test was successfully applied to wrought IN718 by calibrating the Wilshire-Cano-Stewart constitutive model to the SSM data as shown in FIGS. 13A-13B. It was shown to accelerate creep data capture by 6400%, produce a full creep deformation curve to rupture, and produce multi-isotherms of stress-rupture and MCSR data across logarithmic decades given activation energy parameters when compared to conventional data.

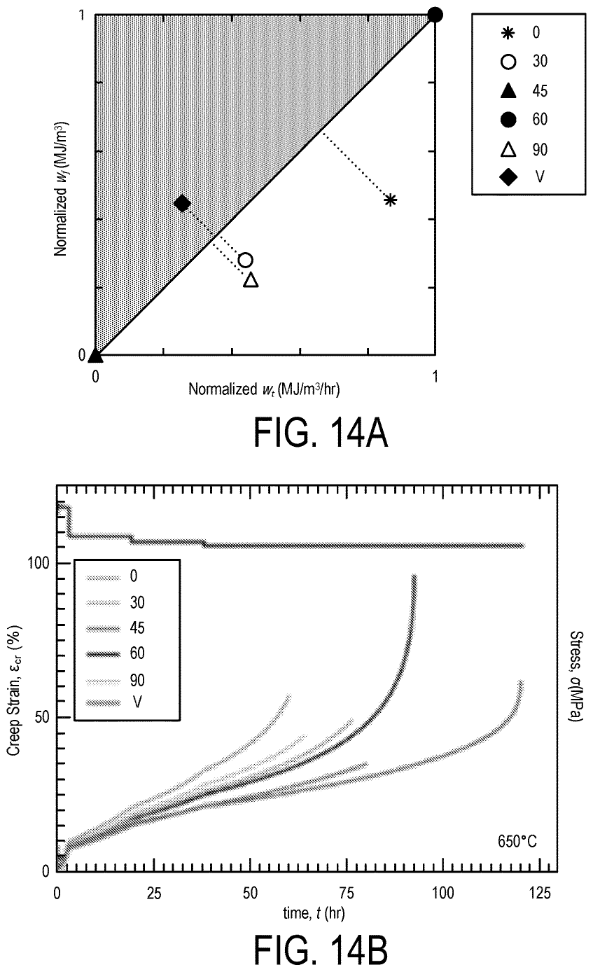

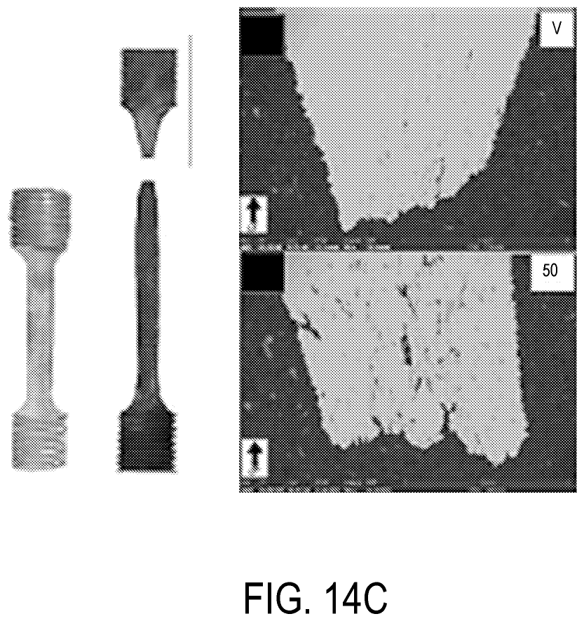

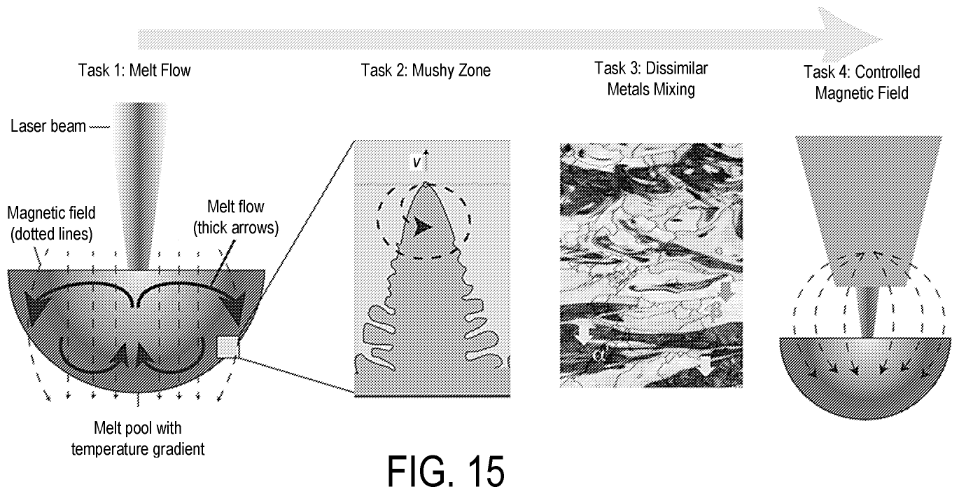

We have also developed a high-throughput screening test of creep resistant AM materials as shown in FIGS. 14A-14C; currently, electron beam melted (EBM) Ti-6Al-4V. A new screening test is in development called the dynamic negative stress tests (DNST), which applies a descending constant load to the material dynamically, keeping the material on the edge of instability. In this “torture” test, materials that survive the longest, with significant ductility, and low initial flow rates are considered ideal. A unifying quantity is found in the strain-energy-density (SED) approach where the SED and the average SED rate act in tandem as screening parameters for creep resistance. In work with EBM Ti-64, we have developed a creep resistance plot that offers instant identification of builds with superior creep resistance (FIG. 14B). Overall, the DNST offers all the advantages of the SSM test with the ability to instantly screen and quantify the creep resistance of AM builds. This is promising where the optimal AM processing and post-processing parameters have yet to be identified and there is a need for relatively quick tests for creep property evaluation.

The strain energy-density (SED) approach is of rising popularity for evaluating the creep-fatigue resistance of materials. In creep and fatigue testing, the SEDs are considered non-local properties that are incorporated into the C*/C(t)-integral and J-integral for fatigue crack growth analysis. While it is not possible to physically measure these integrals, the SED itself can be visualized efficiently using 3D DIC given a specially designed specimen. Elevated temperature fatigue tests on EBM Ti-6Al-4V will be performed to visualize the evolution of SED during hot fatigue. We can use these methods to enable accelerated and rapid screening of AM IN718 MMCs subject to both creep and creep-fatigue conditions and explore the unknowns of the spatially and temporally evolving SED fields during creep-fatigue.

### Impacts

The devices, systems, and methods described herein will tackle materials development challenges and also allow for fewer steps in the process and control for microstructure in AM. Instead of allowing the large thermal gradients, heat accumulation, and columnar grain growth in the DED AM process, the devices, systems, and methods described herein will afford localized microstructures and performance by tuning MMC composition. The technical risks involved include the complexity of capturing and controlling the process physics with laser powder-blown metal AM, including a vapor plume, entrainment of particles, and spattering. However, process monitoring will enable the prediction and control of the process in real-time.

Manufacturing innovation can be in 1) magnetic field manipulation of the melt pool; 2) multiple nozzle deposition with tuned velocities for multi-material printing; and/or 3) process monitoring to quantify the process-structure-property-performance relationships. The following subsections discuss other impacts of the proposed technology, including mechanical performance:

A major challenge in qualifying the creep-fatigue interaction of materials is gathering the underlying creep resistance. Creep is a real-time process that occupies testing equipment for a minimum duration of the code qualification requirement (ASME BPVC III), which calls for 10,000 hours of creep testing (up to 30,000 hours depending on metastability) for each HEAT. Consequently, creep testing requires multiple laboratories running multiple machines to reduce overall qualification time, like with the ongoing Alloy 709 code case. Creep tests are cost intensive as they must be performed spanning the design stress, temperature range, material, time, HEAT, and require multiple labs.

Now consider the advantages (and challenges) of AM, where processing and post-processing parameters are available to tune material chemistry, structure, and properties. This massive material “design space” coupled with long test durations, make the identification of the ideal AM material incredibly slow and cost prohibitive. In fact, a qualification method for elevated temperature AM materials has yet to be codified. High-throughput and rapid screening tests are needed to shorten the timeline for qualification and enable the AM materials genome initiative. The devices, systems, and methods described herein will 1) reduce the time needed to capture creep and creep-fatigue data, 2) capture multiple isostresses and isotherms of data, 3) decrease the volume of manufacturing needed for qualification, (d) provide quantitative resistance measures of creep and creep-fatigue resistance, SED and SED rate which can be exploited for the optimization of AM processing and post-processing parameters.

With fewer steps in the manufacturing process and by using less feedstock as compared to most metal AM processes, the proposed hybrid process will have a smaller carbon footprint and emit less greenhouse gases. In addition, the longer lifespan of the IN718 MMC components at elevated temperatures and with hydrogen exposure will decrease the carbon footprint and increase efficiency of such components. With more efficient and longer-lasting heat exchangers, a carbon-free future and energy supply becomes closer to a reality. Lastly, efficient production of reliable, long-lasting heat exchangers will boost the hydrogen economy with more reliable hydrogen storage and production.

1. An additive manufacturing system for layer-by-layer manufacturing of a three-dimensional build, the additive manufacturing system comprising:
a build platform holding a build under construction;
a deposition head comprising a primary nozzle for directing a particle stream at the build under construction;
a directed energy source for melting the particle stream, thereby forming a melt pool; and
one or more magnets arranged to apply a magnetic field within the melt pool.

2. The system of claim 1, wherein the one or more magnets comprise one or more permanent magnets.

3. The system of claim 1, wherein the one or more magnets comprise an electromagnet

4. The system of claim 3, further comprising a controller coupled to the electromagnet and configured to modulate strength of the magnetic field within the melt pool, shape of the magnetic field within the melt pool, or a combination thereof.

5. The system of claim 1, wherein the one or more magnets are configured to induce a transverse magnetic field through the melt pool.

6. The system of claim 1, wherein the one or more magnets are positioned proximate to the deposition head.

7. The system of claim 1, wherein the one or more magnets are coupled to the deposition head.

8. The system of claim 1, wherein the one or more magnets are circumferentially disposed around the particle stream.

9. The system of claim 1, wherein the one or more magnets are circumferentially disposed around an energy beam emitted from the directed energy source.

10. The system of claim 1, wherein one or more magnets are arranged such that a distance between the one or more magnets and the melt pool remains substantially constant throughout layer-by-layer manufacturing of the three-dimensional build.

11. The system of claim 1, wherein one or more magnets are configured to influence melt pool fluid flow.

12. The system of claim 1, wherein one or more magnets control the melt pool dimensions.

13. The system of claim 1, wherein the system further comprises an auxiliary powder nozzle arranged to direct an additive powder stream at the melt pool.

14. The system of claim 13, further comprising a controller coupled to the auxiliary powder nozzle and configured to modulate gas pressure within the auxiliary powder nozzle, thereby altering a velocity of the additive powder stream.

15. The system of claim 13, wherein the auxiliary powder nozzle is separate and spaced apart from the deposition head.

16. The system of claim 13, wherein the auxiliary powder nozzle is sized to deliver a stream of single additive powder particles to the melt pool.

17. An additive manufacturing system for layer-by-layer manufacturing of a three-dimensional build, the additive manufacturing system comprising:
a build platform holding a build under construction;
a deposition head comprising a primary nozzle for directing a particle stream at the build under construction;
a directed energy source for melting the particle stream, thereby forming a melt pool; and
an auxiliary powder nozzle arranged to direct an additive powder stream at the melt pool.

18-32. (canceled)

33. An additive manufacturing system for layer-by-layer manufacturing of a three-dimensional build, the additive manufacturing system comprising:
a build platform holding a build under construction;
a deposition head comprising a primary nozzle for directing a particle stream at the build under construction;
a directed energy source for melting the particle stream, thereby forming a melt pool;
an auxiliary powder nozzle arranged to direct an additive powder stream at the melt pool; and
one or more magnets arranged to apply a magnetic field within the melt pool.

34-53. (canceled)

54. A method of forming a three-dimensional build by layer-by-layer additive manufacturing, the method comprising
providing the system of claim 1,
directing a particle stream comprising a material from the deposition head at a build under construction while emitting an energy beam from the directed energy source to melt the particle stream, thereby forming a melt pool and growing the build under construction.

55. A build prepared by the method of claim 54.
